(19) United States
(12) Patent Application Publication
(10) Pub. No.: US 2013/0262339 A1
(43) Pub. Date: Oct. 3, 2013

(54) System and Method for Lien Portfolio Management

(71) Applicant: LIENLOG, LLC, Fort Lee, NJ (US)

(72) Inventor: Igor Kirtchakov, Fort Lee, NJ (US)

(73) Assignee: LienLog, LLC, Fort Lee, NJ (US)

(21) Appl. No.: 13/851,381

(22) Filed: Mar. 27, 2013

Related U.S. Application Data
(60) Provisional application No. 61/730,662, filed on Nov. 28, 2012.
(60) Provisional application No. 61/616,754, filed on Mar. 28, 2012.

(51) Int. Cl. G06Q 40/06

(52) U.S. Cl. CPC G06Q 40/06
USPC 705/36 R

(57) ABSTRACT

A lien portfolio management platform is presented that includes a management module operable on a cloud computer. The module accepts lien-relevant data in a predefined format and provides a common valuation methodology thereby facilitating trading of liens. Encrypted data is stored on a cloud database. The module produces predicted performance-parameters of a lien in real-time, such as graphics showing a total-investment and a total value of the lien over time. The data includes lien purchase amount, date and interest rates, as well as information about property underlying the lien, including location, market value, condition and owner. The management module also provides managers of calendar and correspondence, data import and export, documents and attachments, performance, redemption and foreclosure, and acquisition analysis. The platform also includes modules for pre-auction, redemption/foreclosure and servicing. These provide reverse, what if, calculations that give a price to bid to obtain a desired investment performance.

### CLAIM OF PRIORITY

This application claims priority to U.S. Provisional Application No. 61/730,662 filed on Nov. 28, 2012, and U.S. Provisional Application No. 61/616,754 filed on Mar. 28, 2012 the contents of both of which are fully incorporated herein by reference.

### FIELD OF THE INVENTION

The invention relates to a system and method for managing a portfolio of liens, and more particularly, to a cloud based, software supported platform for providing an integrated suite of tools designed for optimal support of, and sharing of, all aspects of managing liens.

### BACKGROUND OF THE INVENTION

Liens, particularly tax liens, offer an attractive investment opportunity that may be low risk, yet have a high yield relative to other low risk investment options available to the general public.

A lien is a legal claim of one person upon the property of another to secure the payment of a debt, or the satisfaction of an obligation.

For instance, when a person fails to pay property or other taxes or fines, the taxing authority typically has the legal right to issue a lien against that person's property. This means that unless the debt is paid in full, including interest and penalties, within a predetermined time-frame, the taxing authority has the legal right to take full possession of the person's property.

In the USA an average of 65% of municipal budgets are covered by local property taxes. It is not, therefore, surprising that municipalities use liens, particularly property tax liens, as a means to ensure that property and other taxes are paid in a timely manner.

Municipalities are, however, typically not interested in owning property, but they do want the tax revenues paid as soon as possible. They, therefore, sell the liens to third parties who pay both the debt and any future taxes due, in return for them now owning the lien. In the case of property taxes, selling liens is typically done by the municipalities auctioning the lien certificate on the property. In exchange for paying all the taxes, the owner of the lien certificate gets the right to either collect the redemption value of the lien certificate or, once the lien's redemption period expires, to foreclose on, and therefore own, the property on which the lien is secured. The lien's redemption value typically includes all the taxes paid, interest on the taxes and any penalties incurred in late payment of the taxes. The interest rate is typically set by state law, and is typically of the order of 15% per annum. As the property securing the lien is usually orders of magnitude more valuable than the amount of taxes involved, property tax lien certificates may be both a very safe and a very lucrative investment.

Lien certificates are, however, not widely owned by the general public. This is due to a number of factors. The rules governing the auction of the liens, and the factors affecting their redemption value, vary from state to state and tend to be complex. The general public is also reluctant to have the possibility of having to resort to foreclose in order to realize the value of their investment. There is also no viable, liquid secondary market for buying and selling lien certificates.

Many of these difficulties have a common cause—a lack of suitable tools, particularly software management tools.

Most tax lien investors use home-grown management solutions, typically based on standard office productivity software such as word processors, spreadsheets and calendars. These tools may be effective for an individual for organizing information on a small scale, but they lack automation. All tasks are handled manually, which is typically time consuming, tedious and error-prone. Another major challenge is that such solutions are highly personalized, with idiosyncratic formatting and arrangement of data. This lack of a standard format makes it extremely difficult to share data with other investors, something that is typically required in transactions such as due diligence, assignment and financing.

The present invention is a tool rich platform that addresses these shortcomings.

The relevant prior art includes:

U.S. Pat. No. 7,693,765 issued to Dell Orfano on Apr. 6, 2010 entitled “System and method for creating electronic real estate registration” that describes a system for providing a registered land asset includes a property transaction database in communication with a computer network the property transaction database provides information related to transactions associated with each registered land asset parcel, each land parcel having a registered land asset identifier representing global coordinates particular to the parcel. The system also includes a location characteristic database in communication with the computer network. The location characteristic database provides socioeconomic data regarding the location wherein the land parcel associated with the registered land asset is situated. A registered land asset contract may give a leaseholder an option to purchase the land by the end of a given term. A computer receives data from the property transaction database and the location characteristic database via the computer network and calculates prices and values associated with a registered land asset contract associated with the land parcel and a registered land asset contract is recorded in association with the land asset identifier corresponding to the land parcel in an electronic land title registry in communication with the computer network.

U.S. Pat. No. 7,835,986 issued to Serio on Nov. 16, 2010 entitled “System and method for monitoring events associated with a person or property” that describes a system and method for retrieving a transaction associated with a property including obtaining property information pertaining to a property from a third party source, storing the property information in a database, receiving a name to monitor or an address of a property to monitor, and transmitting a property information request including the name and/or address to the database. The system and method may also include searching the property information for a match with the name or address, identifying a transaction associated with the matched name or address and transmitting the transaction to a device.

U.S. Pat. No. 7,945,495 issued to Hill et al. on May 17, 2011 entitled “Integrated on-line system for identifying and valuing foreclosure properties” that describes a system and method that coordinates data and provides information to an external subscriber to the system relating to at least one foreclosure real estate transaction. The system comprises: (a) a centralized transaction coordination system for accessing a transaction database; (b) at least one interface device for accessing said transaction coordination system, each interface device associated with a party to said real estate transaction; (c) information relevant to said real estate transaction being provided directly to said transaction coordination system by at least one information originating party originating said information; (d) said information being stored in said transaction database; and (e) said information being accessible by at least one party having registered access to said real estate transaction database using said at least one interface device to access said transaction coordination system, the system comprising software enabling the creation and transmission of jurisdictionally required notice of a foreclosure based upon information input to the data base by authorized sources.

U.S. Pat. No. 7,933,820 issued to Jafa et al. on Apr. 26, 2011 entitled “Method and apparatus for compiling data from property title documents” that describes a method and apparatus for collecting property data from sources using a mobile device, such as a tablet pc, and to upload that property data to a database. The property data is then proofed and immediately returned to the searcher using the mobile device for error corrections. If there are no errors, the method and apparatus of the invention saves the data and returns the requested property data to the requester. If there are errors, the method and apparatus of this invention requests revisions from the searcher, proofs the order again, and returns the requested property data to the requester.

Various implements are known in the art, but fail to address all of the problems solved by the invention described herein. Embodiments of this invention are illustrated in the accompanying drawings and will be described in more detail herein below.

### SUMMARY OF THE INVENTION

The present invention relates to a lien portfolio management platform. In a preferred embodiment the lien portfolio management platform includes a management software module that may be operable on a cloud computer to facilitate access to it.

The management module is typically a computer software package that contains instructions that enable a date processor, such as the cloud computer or other computer system, to perform various functions.

In a preferred embodiment, the functions may include, but are not limited to, the following examples.

The management module may accept lien-relevant data, preferably supplied in a predefined format, and which may be received from a user or a customer. The lien-relevant data may be imported via a predefined application data interface (API) that may, for instance, specify the structure or format of the data. By having liens recorded in a single, standard format, data exchange between the various interested parties may be simplified, facilitating trading and other financial uses of liens.

For security and confidentiality, the lien-relevant data may be encrypted and stored on a cloud resident database. The lien-relevant data may also be backed up, preferably on a physically separate cloud based database, in the form of, for instance, an encrypted copy of the original information.

Other functions performed by the management module may, for instance, include receiving instructions to perform a particular type of analysis of the lien-relevant data, and then performing that analysis to produce a set of lien performance-parameters and predictions. These performance parameters may establish a shared methodology for evaluating the value of, and predicting the future investment performance of liens, thereby facilitating lien related activity such as, but not limited to, trading in liens, investment in liens and the use of liens as collateral for loans, or some combination thereof.

The set of lien performance-parameters may, for instance, be performed in real-time, i.e., within a few seconds, or so that an average user does not notice any perceptible delay.

In a preferred embodiment the set of lien performance-parameters may include graphics, such as, but not limited to, a time-line that displays a graphic of the total-investment that has been, or will be, made in a particular lien as a function of time. That graphic may be overlaid with other graphics, such as, but not limited to, one showing the total-value of the same lien as a function of time. Such graphics may be useful in helping users to easily understand the value and function of lien related financial products.

The management module may also deliver the set of lien performance-parameters generated to the user via the predefined application programming interface (API) and a suitable secure data network connection.

The lien-relevant data may include a lien description that may, for instance, contain information about the amount of the investment, the purchase date of the lien, the interest rate and other relevant data.

The lien-relevant data may also include a description of collateral involved that may, for instance, contain information about the property underlying the security such as, but not limited to, the location of the property, the market value of the property, the condition of the property, the beneficial owners of the property or some combination thereof.

The lien-relevant data may also include an acquisition description that may, for instance, contain information such as, but not limited to, the date of purchase of the lien certificate, the original date of issue of the lien certificate, the anticipated redemption date of the certificate or some combination thereof.

The management module may also include software modules that may provide functions such as, but not limited to, a calendar and correspondence manager, a data import and export manager, a document and attachment manager, a presentation of performance manager, a redemption and foreclosure manager, a performance manager, an acquisition analysis manager, a collateral information manager or some combination thereof.

The lien portfolio management platform may also include other software modules for lien related activities such as, but not limited to, pre-auction, redemption/foreclosure and servicing or some combination thereof.

In addition to providing lists of the dates and place of auctions, and the liens to be auctions, these modules may, for instance, provide capabilities such as, but not limited to, reverse, what if, calculations that give a price to bid to obtain for a particular lien to obtain a desired investment performance.

Therefore, the present invention succeeds in conferring the following, and others not mentioned, desirable and useful benefits and objectives.

It is an object of the present invention to provide an integrated platform for the management of lien certificates.

It is another object of the present invention to provide support for customers, including the general public, to acquire exchange, manage and value their lien certificates.

Yet another object of the present invention is to provide lien relevant information in a uniform manner so as to facilitate the exchange of lien relevant information, thereby providing support for a liquid secondary market in liens.

Still another object of the present invention is to provide software tools that provide a uniform valuation of liens, and predicted lien performance, thereby providing support for lien backed financing and trading.

### BRIEF DESCRIPTION OF THE DRAWINGS

FIG. 1 shows a schematic overview of a lien portfolio management platform that may provide support for customers, an online market in liens and lien backed financing.

FIG. 2 shows a schematic overview of one embodiment of a lien portfolio management platform and some of the interactions with users and other elements of the lien portfolio management platform.

FIG. 3 shows a schematic overview of one embodiment of a management module of the present invention.

FIG. 4 shows a schematic flow chart of some of the steps in using one embodiment of a management module of the present invention.

FIG. 5 shows a schematic graphical, lien performance generated using one embodiment of a management module of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

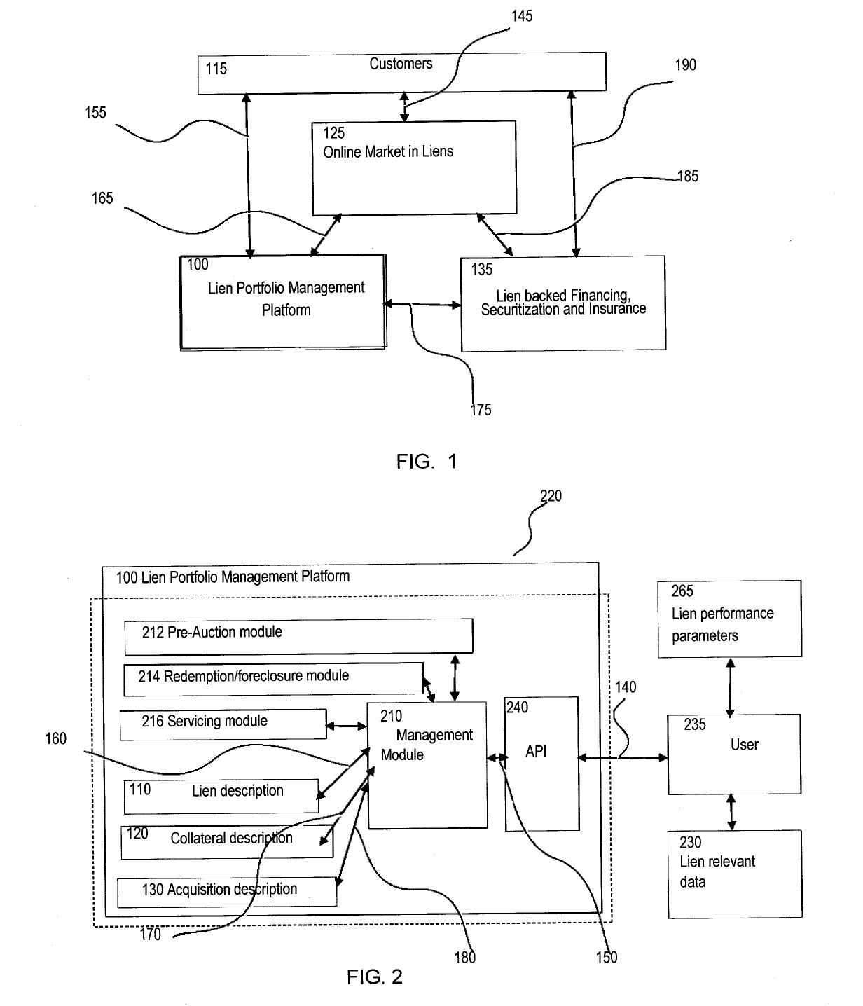

FIG. 1 shows a schematic overview of how a lien portfolio management platform 100 may interact with, and provide support for other elements of a lien eco-system that may include elements such as, but not limited to, customers 115, an online market in liens 125 and lien backed financing 135.

The lien portfolio management platform 100 may, for instance, have direct, secure communication links 155 to one or more customers that may, for instance, enable the customers 115 to perform their analysis and record keeping in a single place, in a single format, or a set of formats, that may be compatible with other customers. The lien portfolio management platform 100 may, for instance, only accept lien-relevant data 230 in a predefined format and/or via one or more predefined application programming interfaces (API) 240 so as to simplify exchanging the data between various interested parties.

The communication links 155 between customers and a lien portfolio management platform may also enable the customers 115 to interact more easily in an online market in liens 125 as they may have compatible formats for data and compatible metrics for measuring and valuing liens, both of which may contribute significantly to facilitating a liquid, functional market in liens and lien portfolios.

The lien portfolio management platform 100 may also have direct, secure communication 165 to the online market in liens. Although each customer 115 account on the lien portfolio management platform 100 may be confidential and not shared, the lien portfolio management platform 100 may be able to anonymously aggregate data to deduce trends and to provide average or median values for liens by criteria such as, but not limited to, location, state, municipality, date of purchase, amount of purchase, end result or outcome, i.e., redemption, early redemption, foreclosure, contested foreclosure or some combination thereof.

There may also be direct, secure communication 175 between the lien portfolio management platform and one or more lien backed financing 135 operations. Such communications may, for instance, allow the lien backed financing 135 operations to evaluate liens, or lien portfolios, as collateral for loans, or to determine, or estimate, the predicted risks and returns of financing all or part of a purchase of a lien or a portfolio of liens.

There may also be direct, secure communication 185 between the liens backed financing operation and the online market in liens 125, and communications 190 between the lien backed financing 135 operations and their customers 115.

These communications may all use lien-relevant data 230 arranged in one or more predefined, common formats, all of which may be compatible with each other. The communications may all be done via one or more predefined application programming interfaces (API) 240 that may help maintain the uniformity of the type of data and the form in which it is presented and used.

In a preferred embodiment, the lien portfolio management platform 100 may include one or more management modules 210 operable on one or more cloud-based computers 220. The management modules 210 may, for instance, include a set of programming instructions that enable the cloud computers to perform a variety of lien relevant functions, as described in more detail below.

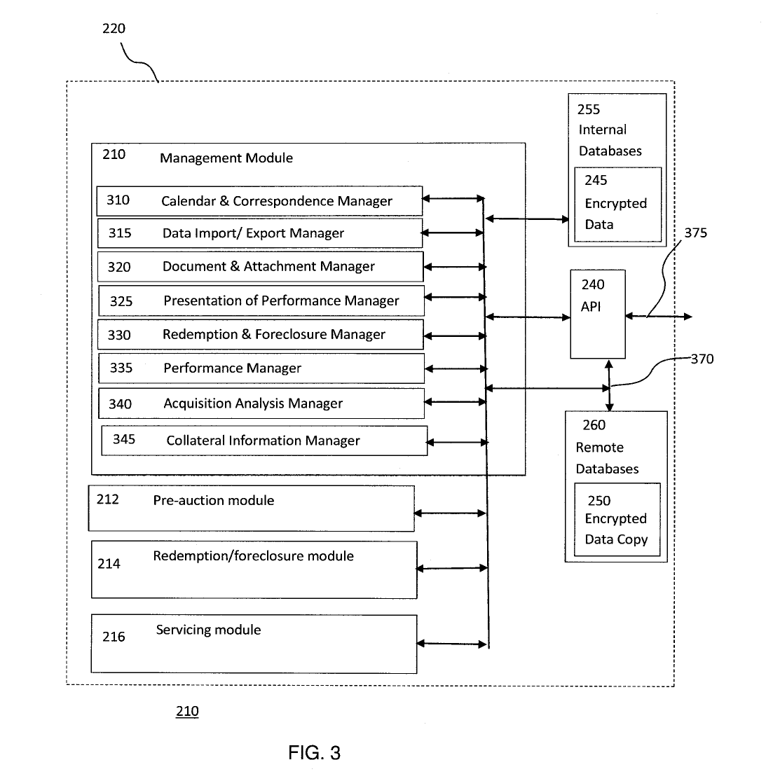

FIG. 2 shows a schematic overview of one embodiment of a lien portfolio management platform 100.

In a preferred embodiment, a cloud computer 220 may host a lien portfolio management platform 100 that may include a predefined application programming interface (API) 240, a management module 210 and a variety of other functional modules and local or working-data stores. The management module 210 may, for instance, communicate 140 with a first user 235 via a predefined application programming interface (API) 240.

The first user 235 may have lien-relevant data 230 and a set of lien performance-parameters 265 related to one or more liens the user owns or wishes to acquire via auction, trade or some such suitable means.

The management module 210 may, for instance, receive lien-relevant data 230 from a user that may, for instance, include data such as, but not limited to, a lien description 110, a collateral description 120 and an acquisition description 130 or some combination thereof. This data may be stored by the management module 210 on the cloud computer 220.

The management module 210 may then receive instructions from the user 235 such as, but not limited to, a request to perform a particular type of analysis of the lien-relevant data 230. The management module 210 may then, in addition to performing its share of analysis on the lien description 110, the collateral description 120 and the acquisition description 130, use other modules that may operate on the cloud computer 220 such as, but not limited to, a pre-auction module 212, a redemption/foreclosure module 214 and a servicing module 216 or some combination thereof.

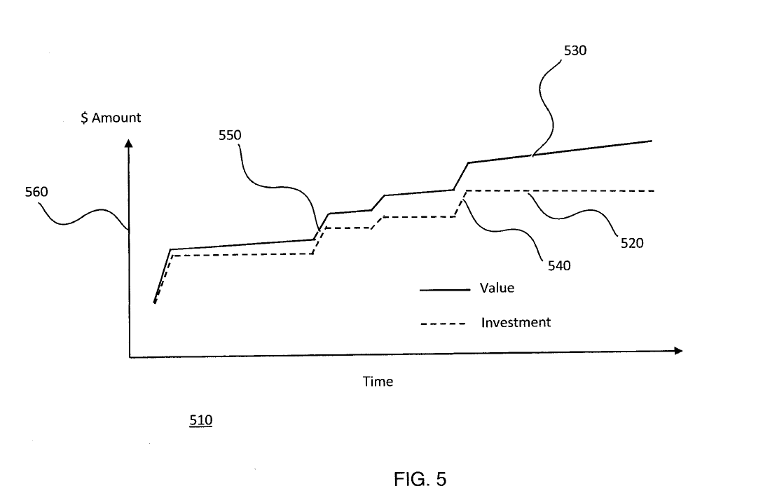

The management module 210 may, therefore, perform the required analysis, preferably in real-time, to produce a set of lien performance-parameters 265. The analysis may make use of one or more predefined algorithms that may be stored on the management module 210. The set of lien performance-parameters 265 may for instance be produced as a graphic time-line 510. The graphic time-line 510 may, for instance, display a graph such as, but not limited to, a graph showing a total-investment in a particular lien against time 520, that may be overlaid with a graph showing a total-value of the particular lien against time 530 (as shown in FIG. 5).

The management module 210 may then deliver the set of lien performance-parameters 265 to the user 235 via a predefined application programming interface (API) 240 that may use a secure connection over a communications link or network such as, but not limited to, the Internet. The information may be delivered in any suitable format such as, but not limited to, spreadsheets, graphs, PDF files, audio or video files, or some combination thereof.

FIG. 3 shows a schematic overview of one embodiment of a management module of the present invention.

In addition to being connected to the predefined application programming interface (API) 240 that interfaces communication 375 between users and the management module, the management module 210 may also be connected to one or more cloud databases 255, 260 and one or more functional modules.

A first cloud database 255 may be an internal database that may be hosted on a different cloud computer and may contain encrypted lien relevant data 245 that may pertain to one or more users, or customers of the system.

A second cloud database 260 may be another internal database that may be hosted on a different cloud computer and may contain an encrypted data backup or copy 250 of some or all of the data on the first cloud database 255.

The management module 210 may include one or more manager modules such as, but not limited to, a calendar and correspondence manager 310, a data import and export manager 315, a data import and export manager 315, a document and attachment manager 320, a presentation of performance manager 325, a redemption and foreclosure manager 330, a performance manager 335, an acquisition analysis manager 340 and a collateral information manager 345, or some combination thereof.

Each of these managers may, for instance, interact with the internal databases 255 to either encrypt and store, or access and decrypt information there. The calendar and correspondence manager 310 may for instance automatically, given a purchase date and purchase jurisdiction of a lien, populate a calendar with action dates such as, but not limited to, interest due dates, redemption dates, or other lien relevant dates, and may then generate appropriate letters, emails, texts as either reminders or as correspondence taking care of the necessary actions.

The data import and export manager 315 may, for instance, undertake tasks such as, but not limited to, encrypting and decrypting data, conforming data to required formats, or some combination thereof. This module may, for instance, facilitate sharing, or exchange of lien relevant data between users by having the data in compatible formats, helping create investor communities and trading and exchange of liens.

Similarly, the acquisition analysis manager 340, the performance manager 335 and the presentation of performance manager 325 may facilitate uniform evaluation of liens, thereby helping users to trade and exchange liens.

The management module 210 may also be connected to other modules such as, but not limited to, a pre-auction module 212, a redemption/foreclosure module 214 and a servicing module 216.

A pre-auction module 212 may, for instance, include information such as, but not limited to, a calendar of auctions, lists of tax liens at the auctions, locations of auctions or some combination thereof. The pre-auction module 212 may be programmed to perform calculations including, but not limited to, reverse calculations in “what if” type interactions in which a user may specify a desired projected performance of a lien or portfolio of liens, and obtain prices at which those performances may be satisfied.

The servicing module 216 may, for instance, keep track of all documents associated with a lien and may for instance, generate the required forms when required and store them throughout the life time of the lien, preferably in forms and formats that allow real-time sharing of the information when necessary.

The redemption/foreclosure module 214 may, for instance, include database that track the rules and regulations of some or all relevant lien locations, and may also generate appropriate timelines, actions lists, generate appropriate documents, and track all documents required in either redemption or foreclosure proceedings.

The redemption/foreclosure module 214 may, for instance, allow conditional access to certain groups such as, but not limited to, read only access to specific files for groups of attorneys conduction due diligence, or overseeing some or all of a redemption or foreclosure proceeding.

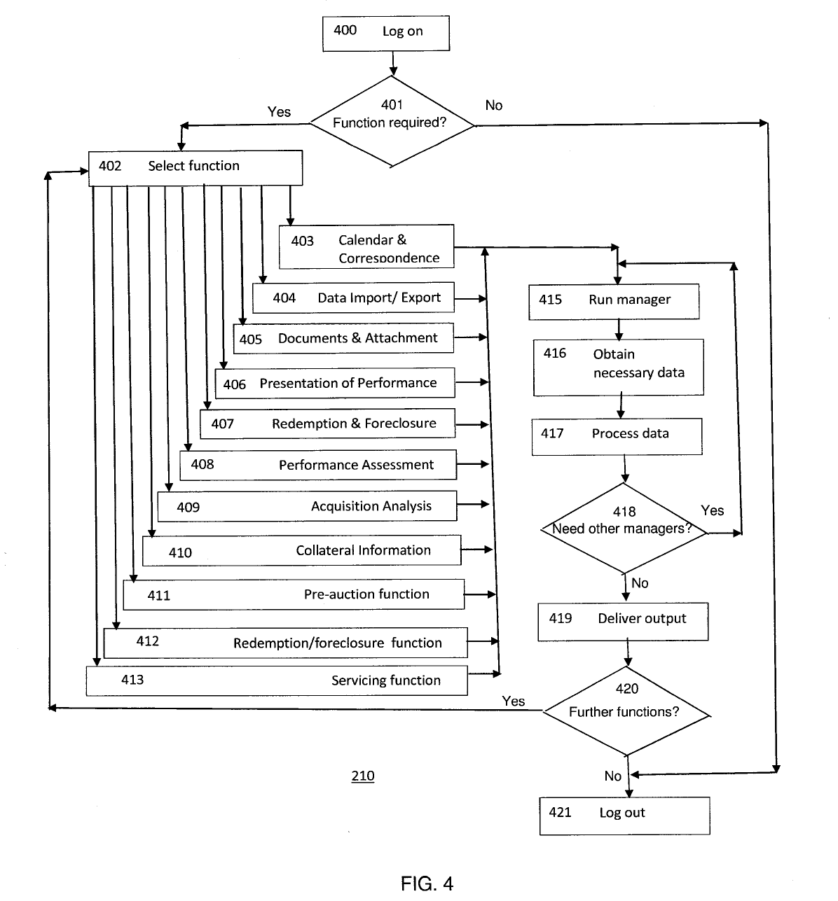

FIG. 4 shows a schematic flow chart of some of the steps in using one embodiment of a management module 210 of the present invention.

In step 400, a user may log on to the system. The lien portfolio management platform 100 may, for instance, be protected by standard challenge-response landing sites that require a user to be pre-registered and to have a secure password.

Once logged on, a registered, authenticated user may then establish a secure, preferably encrypted, connection from their communications device to the lien portfolio management platform 100 via a communications network such as, but not limited to, the Internet.

In a next step 401, a user may select whether a further function is required. If a function is required, the user may proceed to step 402 to select a function. This may, for instance, be done by presenting a user with one or more menus from which they may select. The menus may, for instance allow the user to select a next step from one of steps 403 Calendar & Correspondence, step 404 Data Import/Export, step 405 Documents & Attachment, step 406 Presentation of Performance, step 407 Redemption & Foreclosure, step 408 Performance Assessment, step 409 Acquisition Analysis, step 410 Collateral Information, step 411 Pre-auction function, step 412 Redemption/foreclosure function and step 413 Servicing function.

Once an appropriate function is selected, the management module 210 may proceed to step 415 in which the appropriate function manager may be run.

The next step may be step 416 of obtaining the necessary data for the selected function.

Having obtained the necessary data, the management module 210 may proceed to step 417 of processing data.

At the next step, step 418, the management module 210 may determine if one of the other managers is required such as, but not limited to, the pre-auction module 212, the redemption/foreclosure module 214 or the servicing module 216, as shown in FIG. 3.

If another manager is required, the management module 210 may return to step 415 and run the required manager. The program may then loop through steps 416 back to 418 again.

If no other manager is required, the management module 210 may then proceed to step 419 and deliver the output generated to the user.

In step 420, the user may be asked if any further functions are required. If the user has other functions to be performed, the management module 210 may loop back to step 402 in which the user may select a function to be performed.

If no further functions are required by the user, the user may then proceed to step 421 and log out of the system.

FIG. 5 shows a schematic graphical, lien performance generated using one embodiment of a management module of the present invention.

The graphic time-line 510 shows monitory value 560 plotted on the vertical axis against time on the horizontal axis for a lien.

Two plots are overlaid on the graph. The one graph 530 represents the total-value of a particular lien plotted against time. The second graph 520 represents the total investment in the lien plotted against time.

Both graphs have step increases. In plot 520, the step increase may represents a lien tax payment 540 as may be due on a tax lien secured by a property as the owner of the lien typically assumes future tax liabilities until the lien is redeemed or foreclosed on.

In plot 530, the step increase may represent the increase in redemption value reflecting the lien tax payment 550 once it has been made.

Between step increases, the total-investment in a lien 520 typically remains constant as periodic tax payments are typically the only further investment that may be required in a property tax lien.

Between step increases, the total-value of the lien may increase linearly, as the interest due typically accumulates as compound interest.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A lien portfolio management platform, comprising:
a management module operable on a computer comprising instructions enabling said computer to perform functions, comprising:
accepting lien-relevant data in a predefined format from a first user via a predefined application programming interface (API);
storing said lien-relevant data as encrypted data on a first cloud database, and backing up said stored lien-relevant data, as an encrypted data copy, on a second database located physically distant from said first cloud database;
receiving instructions to perform an analysis of said lien-relevant data;
performing said analysis, using pre-supplied algorithms, to produce, in real-time, a set of lien performance-parameters, said set of lien performance-parameters comprising a graphic time-line displaying a total-investment in a particular lien v. time graphic overlaid with a total-value of said particular lien v time graphic; and
delivering said set of lien performance-parameter to said first user via said predefined application programming interface.

2. The lien portfolio management platform of claim 1 wherein said lien-relevant data further comprises a lien description, a collateral description or an acquisition description.

3. The lien portfolio management platform of claim 1 wherein said management module further comprises a calendar and correspondence manager, a data import and export manager, a document and attachment manager, a presentation of performance manager, a redemption and foreclosure manager, a performance manager, an acquisition analysis manager or a collateral information manager.

4. The lien portfolio management platform of claim 1 further comprising a pre-auction module, said pre-auction module comprising:
a calendar comprising at least one date of an auction date and a location of said auction;
a description of at least one tax lien to be auctioned at said auction; and
a bid offer that will provide a pre-determined projected value performance of said tax lien.

5. The lien portfolio management platform of claim 1 further comprising a servicing module, said servicing module comprising:
one or more documents directly associated with a lien; and
one or more forms generated by said serving module that are directly relevant to said lien.

6. The lien portfolio management platform of claim 1 further comprising a redemption/foreclosure module, said redemption/foreclosure module comprising:
a database having at least one jurisdiction specific, lien relevant redemption rule;
an algorithm for using said redemption rule to generate a lien relevant date; and
a software module for generating a document relevant to said lien relevant date.

7. The lien portfolio management platform of claim 1 further comprising a redemption/foreclosure module, said redemption/foreclosure module comprising:
a database having at least one jurisdiction specific, lien relevant foreclosure rule;
an algorithm for using said foreclosure rule to generate a lien relevant date; and
a software module for generating a document relevant to said lien relevant date.

8. A lien portfolio management platform, comprising:
a management module operable on a computer comprising instructions enabling said computer to perform functions, comprising:
accepting lien-relevant data in a predefined format from a first user;
receiving instructions to perform an analysis of said lien-relevant data;
performing said analysis, using pre-supplied algorithms, to produce a set of lien performance-parameters; and
delivering said set of lien performance-parameter to said first user via said predefined application programming interface.

9. The lien portfolio management platform of claim 8 wherein said lien-relevant data further comprises a lien description, a collateral description and an acquisition description.

10. The lien portfolio management platform of claim 1 wherein said management module further comprises a calendar and correspondence manager, a data import and export manager, a document and attachment manager, a presentation of performance manager, a redemption and foreclosure manager, a performance manager, an acquisition analysis manager and a collateral information manager.

11. The lien portfolio management platform of claim 1 further comprising a pre-auction module, said pre-auction module comprising:
a calendar comprising at least one date of an auction date and a location of said auction;
a description of at least one tax lien to be auctioned at said auction; and
a bid offer that will provide a pre-determined projected value performance of said tax lien.

12. The lien portfolio management platform of claim 1 further comprising a servicing module, said servicing module comprising:
one or more documents directly associated with a lien; and
one or more forms generated by said serving module that are directly relevant to said lien.

13. The lien portfolio management platform of claim 1 further comprising a redemption/foreclosure module, said redemption/foreclosure module comprising:
a database having at least one jurisdiction specific, lien relevant redemption rule;
an algorithm for using said redemption rule to generate a lien relevant date; and
a software module for generating a document relevant to said lien relevant date.

14. The lien portfolio management platform of claim 1 further comprising a redemption/foreclosure module, said redemption/foreclosure module comprising:
a database having at least one jurisdiction specific, lien relevant foreclosure rule;
an algorithm for using said foreclosure rule to generate a lien relevant date; and
a software module for generating a document relevant to said lien relevant date.
